(19) United States
(12) Patent Application Publication
(10) Pub. No.: US 2026/0303727 A1
(43) Pub. Date: Oct. 1, 2026

(54) WIDEBAND DOUBLETALK DETECTION FOR OPTIMIZATION OF ACOUSTIC ECHO CANCELLATION

(71) Applicant: Shure Acquisition Holdings, Inc., Niles, IL (US)

(72) Inventors: Wesley Lethem, Chicago, IL (US); Justin Joseph Sconza, Chicago, IL (US); Christopher George Rieger, Chicago, IL (US)

(21) Appl. No.: 19/564,501

(22) Filed: Mar. 12, 2026

Related U.S. Application Data
(63) Continuation of application No. 18/477,039, filed on Sep. 28, 2023, now Pat. No. 12,598,261.
(60) Provisional application No. 63/377,451, filed on Sep. 28, 2022.

(51) Int. Cl. H04M 9/08

(52) U.S. Cl. CPC H04M 9/082

(57) ABSTRACT

Acoustic echo cancellation systems and methods are provided that improve the quality of the audio transmitted from by an audio device a near end to a far end when a doubletalk condition is present, including allowing certain subbands of an echo-cancelled signal to be less attenuated by overriding certain gains of subbands of the echo-cancelled audio signal in a non-linear processor, and compressing and applying makeup gain to a remote audio signal.

### CROSS-REFERENCE TO RELATED APPLICATION

This application is a continuation of U.S. patent application Ser. No. 18/477,039, filed Sep. 28, 2023 which claims priority to U.S. Provisional Application Ser. No. 63/377,451, filed on Sep. 28, 2022, both of which are incorporated herein by reference in their entirety.

### TECHNICAL FIELD

This application generally relates to acoustic echo cancellation. In particular, this application relates to utilizing the detection of doubletalk conditions to refine and optimize the operation of a non-linear processor used for acoustic echo cancellation.

### BACKGROUND

Conferencing environments, such as boardrooms, conferencing settings, and the like, can involve the use of microphones (including microphone arrays) for capturing sound from audio sources and loudspeakers for presenting audio from a remote location (also known as a far end). For example, persons in a conference room may be conducting a conference call with persons at a remote location. Typically, speech and sound from the conference room may be captured by microphones and transmitted to the remote location, while speech and sound from the remote location may be received and played on loudspeakers in the conference room. The captured sound may also be disseminated to a local audience in the environment through amplified speakers for sound reinforcement. Multiple microphones may be used in order to optimally capture the speech and sound in the conference room.

However, the microphones may pick up the speech and sound from the remote location that is played on the loudspeakers. In this situation, the audio transmitted to the remote location may therefore include an echo, e.g., the speech and sound from the conference room as well as the speech and sound from the remote location. If there is no correction, the audio transmitted to the remote location may be low quality or unacceptable because of this echo. In particular, it would not be desirable for persons at the remote location to hear their own speech and sound.

Acoustic echo cancellation (AEC) systems may be able to remove such echo that is picked up by the microphone before the audio is transmitted to the remote location. However, an AEC system may work poorly and have suboptimal performance if it needs to constantly readapt and/or is overwhelmed, such as when the sound from a physically proximate loudspeaker is detected by the microphone. A non-linear processor in an AEC system is typically utilized to remove residual echo that cannot be removed by an adaptive filter, and to ultimately generate an echo-cancelled audio signal that is transmitted to the far end.

However, when periods of doubletalk occur (e.g., the microphone simultaneously detecting speaking in the room and speaking from the remote location that is playing on the loudspeaker), typical non-linear processors and AEC systems may have difficulty in transmitting high quality speech and sound from the local near end environment to the remote far end location. It may be particularly challenging to transmit high quality near end speech and sound when the microphones and loudspeaker are close to one another (e.g., when they are in the same device and/or housing) due to the energy of the far end audio played on the loudspeaker often being much greater than the energy of the near end audio being detected by the microphone. For example, non-linear processors in typical AEC systems may fully suppress residual echo when there is a doubletalk condition, which can cause the unintended attenuation of desired sound (e.g., near end voice). Furthermore, when the microphones and loudspeaker are close to one another, mechanical vibrations may be introduced by the microphones, the loudspeaker, and/or the housing. Such vibrations may have an excessive influence on the non-linearities introduced in the microphone signal. Since these non-linearities would not be included in the reference signal (e.g., the far end audio), the non-linearities may be perceived as near-end voice.

### SUMMARY

The techniques of this disclosure are directed to solving the above-noted problems by providing systems and methods that are designed to, among other things: (1) allow certain subbands of an echo-cancelled signal to be transmitted by overriding certain gains of the subbands of the echo-cancelled audio signal in a non-linear processor, based on whether a doubletalk condition is detected; (2) compress a remote far end audio signal to reduce its dynamic range in certain bands and limit its volume when it is played on a loudspeaker, based on whether a doubletalk condition is detected; and (3) apply makeup gain to a compressed remote audio signal to minimize fluctuations in the remote audio played on the loudspeaker, based on whether a doubletalk condition is detected.

In an embodiment, a device may include at least one processor that is configured to determine one or more gains of one or more subbands of an initial echo-cancelled audio signal, determine that a doubletalk condition is present in one or more subbands of a microphone signal and a remote audio signal, and when the doubletalk condition is determined to be present: override the one or more gains of the one or more subbands of the initial echo-cancelled audio signal to generate a final echo-cancelled audio signal, transmit the final echo-cancelled audio signal to a remote location, compress the remote audio signal to generate a compressed remote audio signal, and play the compressed remote audio signal on a loudspeaker. The initial echo-cancelled audio signal may be generated based on the microphone signal and the remote audio signal.

In another embodiment, a system may include a microphone configured to generate a microphone signal, a loudspeaker configured to generate sound based on a remote audio signal, and at least one processor. The microphone and the loudspeaker may be located in the same housing. The at least one processor may be configured to determine that a doubletalk condition is present in the microphone signal and the remote audio signal, and when the doubletalk condition is determined to be present: override one or more gains of one or more subbands of an initial echo-cancelled audio signal to generate a final echo-cancelled audio signal, and compress the remote audio signal to generate a compressed remote audio signal for output on the loudspeaker. The initial echo-cancelled audio signal may be generated based on the microphone signal and the remote audio signal.

In a further embodiment, a device may include at least one processor configured to determine that a doubletalk condition is present based on a microphone signal and a remote audio signal, and when the doubletalk condition is determined to be present: override one or more gains of one or more subbands of an initial echo-cancelled audio signal to generate a final echo-cancelled audio signal, and compress the remote audio signal to generate a compressed remote audio signal. The initial echo-cancelled audio signal may be generated based on the microphone signal and the remote audio signal.

In another embodiment, a device may include at least one processor configured to determine that a doubletalk condition is present based on a microphone signal and a remote audio signal, and when the doubletalk condition is determined to be present: override one or more gains of one or more subbands of an initial echo-cancelled audio signal to generate a final echo-cancelled audio signal, wherein the initial echo-cancelled audio signal is generated based on the microphone signal and the remote audio signal. The final echo-cancelled audio signal may be transmitted to a remote location. The initial echo-cancelled audio signal may be generated based on the microphone signal and the remote audio signal.

In a further embodiment, a device may include at least one processor configured to the doubletalk condition is determined to be present based on a microphone signal and a remote audio signal, and when the doubletalk condition is determined to be present: compress the remote audio signal to generate a compressed remote audio signal, and play the compressed remote audio signal on a loudspeaker.

In another embodiment, a method includes determining that a doubletalk condition is present in one or more subbands of a microphone signal and a remote audio signal, and when the doubletalk condition is determined to be present: overriding one or more gains of one or more subbands of an initial echo-cancelled audio signal to generate a final echo-cancelled audio signal, transmitting the final echo-cancelled audio signal to a remote location, compressing the remote audio signal to generate a compressed remote audio signal, and playing the compressed remote audio signal on a loudspeaker. The initial echo-cancelled audio signal may be generated based on the microphone signal and the remote audio signal.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram of a communication system including an acoustic echo cancellation system that includes a non-linear processor, a doubletalk detector, and a compressor, in accordance with some embodiments.

FIG. 2 is a schematic diagram of portions of the doubletalk detector and the non-linear processor in the acoustic echo cancellation system of FIG. 1, in accordance with some embodiments.

FIG. 3 is a schematic diagram of the multiband compressor in in the acoustic echo cancellation system of FIG. 1, in accordance with some embodiments.

FIG. 4 is a flowchart illustrating operations of the communication system of FIG. 1 based on the presence of a doubletalk condition, in accordance with some embodiments.

FIG. 5 is a flowchart illustrating operations of the doubletalk detector in the acoustic echo cancellation system of FIG. 1, in accordance with some embodiments.

FIG. 6 is a flowchart illustrating operations of the compressor in the acoustic echo cancellation system of FIG. 1, in accordance with some embodiments.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

The systems and methods described herein can override the operation of a non-linear processor in an acoustic echo cancellation (AEC) system when a doubletalk condition is present by modifying the gains of the non-linear processor such that certain frequency bands of an initial echo-cancelled audio signal are less attenuated for transmission from the near end to the far end. The frequency bands with modified gains may be those that contain desired sound, such as near end speech. Likewise, other frequency bands of the initial echo-cancelled audio signal (e.g., that contain undesired sound) may still be attenuated by the non-linear processor. The resulting final echo-cancelled signal generated by a non-linear processor utilizing these systems and methods may therefore have a higher quality by including more desired sound in the audio that is played at the far end and/or at the near end (e.g., for sound reinforcement). In embodiments, a non-linear processor may be known as an echo suppressor.

A doubletalk condition may include when the microphone simultaneously detects speech in the room and speech from the remote location that is playing on the loudspeaker, for example. The systems and methods described herein may determine that there is a doubletalk condition when desired sound is detected in certain frequency bands on a microphone signal and a remote audio signal even while undesired sound is also detected in those frequency bands, and where the number of frequency bands with a doubletalk condition meet a criteria. In this situation, it can be assumed that desired sound may be present in the near end audio in all frequency bands of the initial echo-cancelled audio signal, and therefore that the gains of the non-linear processor for frequency bands without a doubletalk condition can be modified to reduce the attenuation of these frequency bands. In the frequency bands that do not have a doubletalk condition, desired sound is presumed to be present because the energy of the near end audio being detected by the microphone is greater than the energy of the far end audio played on the loudspeaker. However, the gains of the non-linear processor for frequency bands that have a doubletalk condition may be left unmodified because the energy of the far end audio being played on the loudspeaker is greater than the energy of the near end audio being detected by the microphone.

Other systems and methods described herein can, when a doubletalk condition is present, compress the remote audio signal from the far end that is typically being played on a loudspeaker at the near end. Compressing the remote audio signal can reduce its dynamic range and lower its volume in order to reduce the energy of the remote audio signal relative to the energy of near end audio, as well as reduce artifacts of the mechanical housing due to resonance at certain frequencies. Performing such a compression of the remote audio signal may improve the physical characteristics of the audio device and subsequently the operation of the non-linear processor in the AEC system when a doubletalk condition is present by reducing the potential attenuation of desired sound detected by the microphone. Further systems and methods described herein can also apply makeup gain to the compressed remote audio signal when a doubletalk condition is present in order to minimize fluctuations when the remote audio signal is played on the loudspeaker to have a more consistent audio level.

Through use of these systems and methods, the operation of an audio device may be optimized by improving the quality of the audio from a near end when a doubletalk condition is present. For example, even in situations when there is a doubletalk condition, at least some speech from the near end may be transmitted to a far end so that the far end participants are still able to hear the near end participants. Such speech from the near end may also be used for local sound reinforcement. Audio devices where a microphone and a loudspeaker are in close proximity to one another, e.g., in the same housing, may particularly benefit from these systems and methods. The occurrence of the undesirable echo of persons at a remote location hearing their own speech and sound can be reduced using these systems and methods when there is a doubletalk condition, while enabling more of the speech and sound from the near end to be transmitted to the remote location. The higher audio quality of the audio device may result in greater user satisfaction at both the near end and the far end when there is a doubletalk condition.

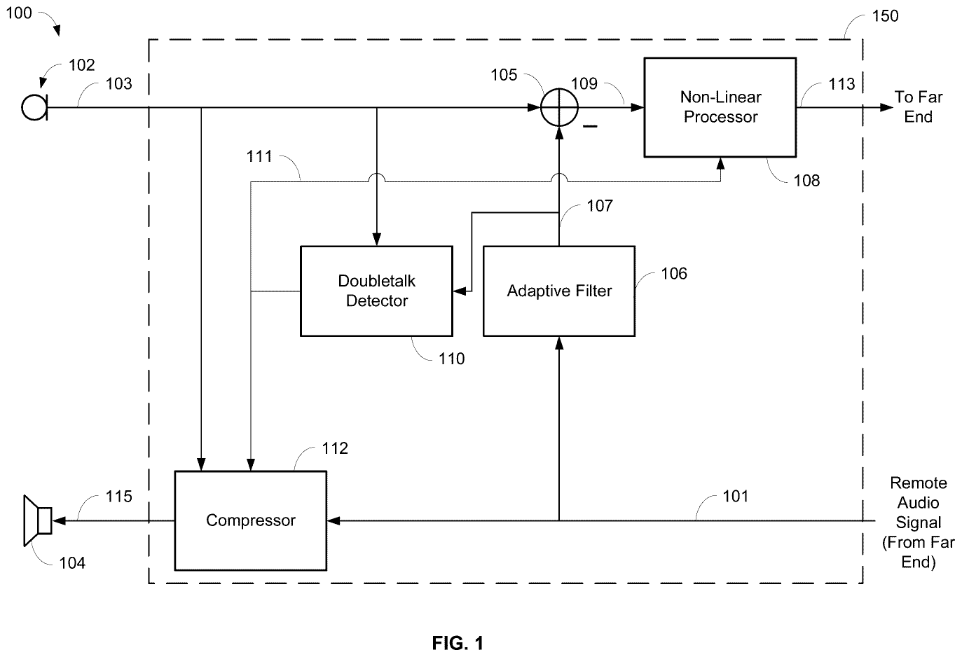

FIG. 1 is a schematic diagram of a communication system 100 for capturing sound from audio sources in an environment using a microphone 102 and presenting audio from a remote location using a loudspeaker 104. The communication system 100 may include an acoustic echo cancellation system 150 that includes an adaptive filter 106, a non-linear processor 108, a doubletalk detector 110, and a compressor 112. When a doubletalk condition is detected by the doubletalk detector 110, the gains of the non-linear processor 108 can be modified in certain frequency bands of an initial echo-cancelled audio signal 109 in order to allow desired sound in these frequency bands to be less attenuated for transmission to the far end. Furthermore, the compressor 112 can compress and apply makeup gain to the remote audio signal 101 when a doubletalk condition is detected by the doubletalk detector 110. These and other embodiments can improve the overall operation of the acoustic echo cancellation system 150, and are described in more detail below.

The communication system 100 may generate an echo-cancelled audio signal 113 using the acoustic echo cancellation system 150. The echo-cancelled audio signal 113 may mitigate the sound received from the remote location that is played on the loudspeaker 104, and in particular, mitigate linear echo and residual echo that is sensed by the microphone 102. In this way, the echo-cancelled audio signal 113 may be transmitted to the remote location without the undesirable echo of persons at the remote location hearing their own speech and sound.

Environments such as conference rooms may utilize the communication system 100 to facilitate communication with persons at the remote location, for example. The type of microphone 102 and its placement in a particular environment may depend on the locations of audio sources, physical space requirements, aesthetics, room layout, and/or other considerations. For example, in some environments, the microphone 102 may be placed on a table or lectern near the audio source. In other environments, the microphone 102 may be mounted overhead to capture the sound from the entire room, for example. The communication system 100 may work in conjunction with any type and any number of microphones 102, including array microphones. The microphone 102 and the loudspeaker 104 may be located in the same housing, in some embodiments, or may be in separate housings, in other embodiments.

Various components included in the communication system 100 may be implemented using software executable by one or more servers or computers, such as a computing device with a processor and memory, and/or by hardware (e.g., discrete logic circuits, application specific integrated circuits (ASIC), programmable gate arrays (PGA), field programmable gate arrays (FPGA), etc. In general, a computer program product in accordance with the embodiments includes a computer usable storage medium (e.g., standard random access memory (RAM), an optical disc, a universal serial bus (USB) drive, or the like) having computer-readable program code embodied therein, wherein the computer-readable program code is adapted to be executed by a processor (e.g., working in connection with an operating system) to implement the methods described herein. In this regard, the program code may be implemented in any desired language, and may be implemented as machine code, assembly code, byte code, interpretable source code or the like (e.g., via C, C++, Java, ActionScript, Python, Objective-C, JavaScript, CSS, XML, and/or others).

In FIG. 1, the microphone 102 may detect sound in the local near end environment and convert the sound to an audio signal 103. In embodiments, the microphone 102 may include multiple microphone elements that generate multiple audio signals 103 that can be processed by a beamformer (not shown) to generate one or more beamformed audio signals. Accordingly, while the systems and methods are described herein as using an audio signal 103 from microphone 102, it is contemplated that the systems and methods may also utilize any type of acoustic source, such as beamformed audio signals generated by a beamformer. In addition or alternatively, the audio signal 103 from the microphone 102 and the remote audio signal 101 may be converted into the frequency domain, in which case, the acoustic echo cancellation system 150 can operate in the frequency domain.

The adaptive filter 106 may process the remote audio signal 101 to generate a filtered remote audio signal 107 that is an estimate of the acoustic path of the remote audio signal 101, e.g., a model of the echo that will be detected by the microphone 102. In embodiments, the adaptive filter 106 may be a finite impulse response filter. The filtered remote audio signal 107 generated by the adaptive filter 106 may be subtracted from the audio signal 103 of the microphone 102 at the summing point 105 to generate an initial echo-cancelled audio signal 109. Linear echo in the microphone audio signal 103 may be suppressed in the initial echo-cancelled audio signal 109

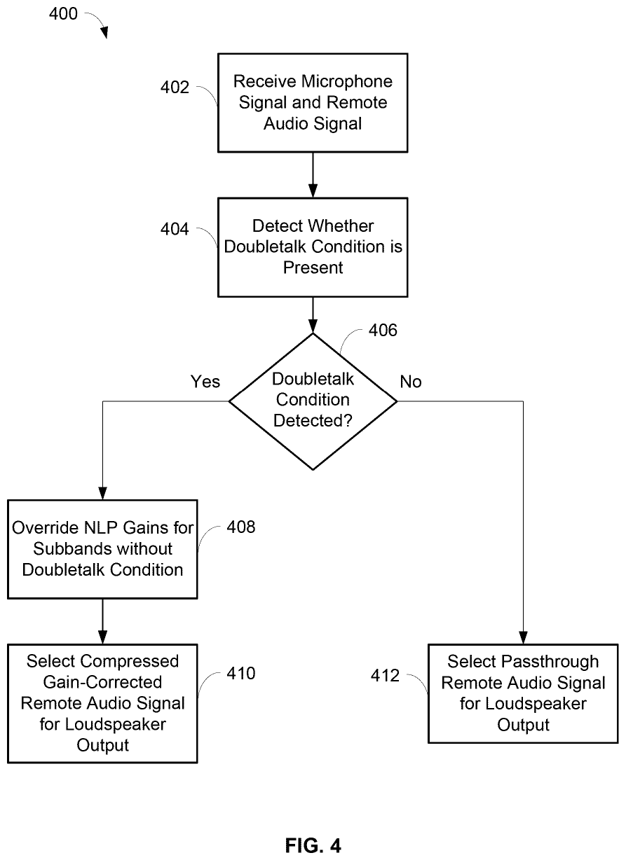

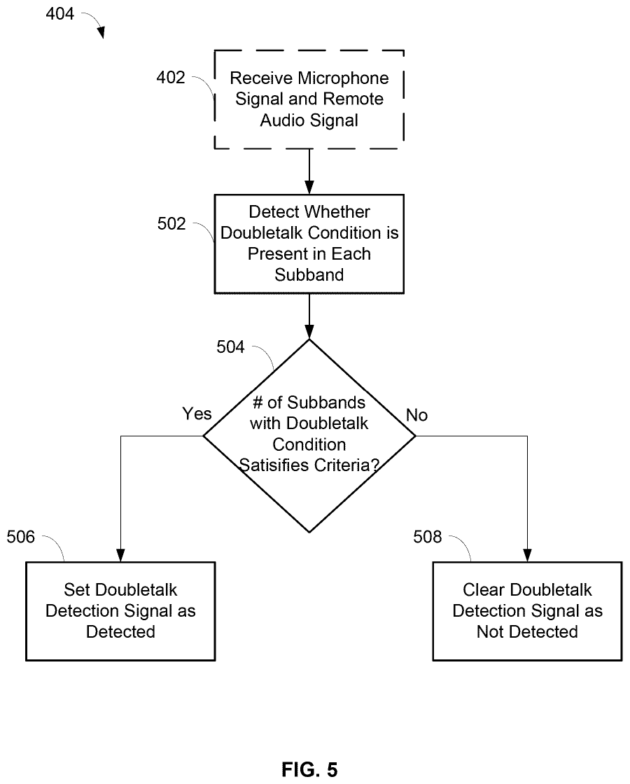

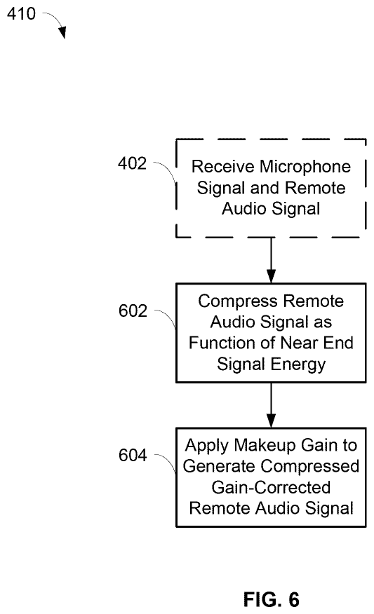

FIGS. 4-6 illustrate exemplary methods for utilizing the communication system 100 and the acoustic echo cancellation system 150. In particular, FIG. 4 illustrates a method 400 for operating the acoustic echo cancellation system 150 based on whether a doubletalk condition is present, FIG. 5 illustrates a method 404 for determining whether a doubletalk condition is present using the doubletalk detector 110, and FIG. 6 illustrates a method 410 for operating the compressor 112 when a doubletalk condition is present. Each of these processes is described in more detail below. One or more processors and/or other processing components (e.g., analog to digital converters, encryption chips, etc.) within or external to the communication system 100 may perform any, some, or all of the steps of the methods 400, 404, and/or 410. One or more other types of components (e.g., memory, input and/or output devices, transmitters, receivers, buffers, drivers, discrete components, etc.) may also be utilized in conjunction with the processors and/or other processing components to perform any, some, or all of the steps of the methods.

As shown in the method 400 of FIG. 4, at step 402, the acoustic echo cancellation system 150 may receive an audio signal 103 from the microphone 102, as well as a remote audio signal 101. The microphone audio signal 103 may typically include sound in the near end environment, such as speech from local participants, while the remote audio signal 101 may typically include sound from the far end environment, such as speech from remote participants. At step 404, the doubletalk detector 110 may determine that a doubletalk condition is present, based on the microphone audio signal 103 and the remote audio signal 101. The doubletalk detector 110 may determine whether there is a doubletalk condition in each of the subbands of the microphone audio signal 103 and the remote audio signal 101, and also determine whether an overall doubletalk condition is present based on the number of subbands that have a doubletalk condition. When an overall doubletalk condition has been detected at step 404, the doubletalk detector 110 may determine that a doubletalk condition is present such as by setting a doubletalk detection signal 111 to denote that there is an overall doubletalk condition, in some embodiments. Conversely, when an overall doubletalk condition has not been detected at step 404, the doubletalk detector 110 may determine that a doubletalk condition is not present such as by clearing the doubletalk detection signal 111 to denote that there is not an overall doubletalk condition, in some embodiments. In other embodiments, other suitable signals may be utilized to denote whether there is an overall doubletalk condition at step 404.

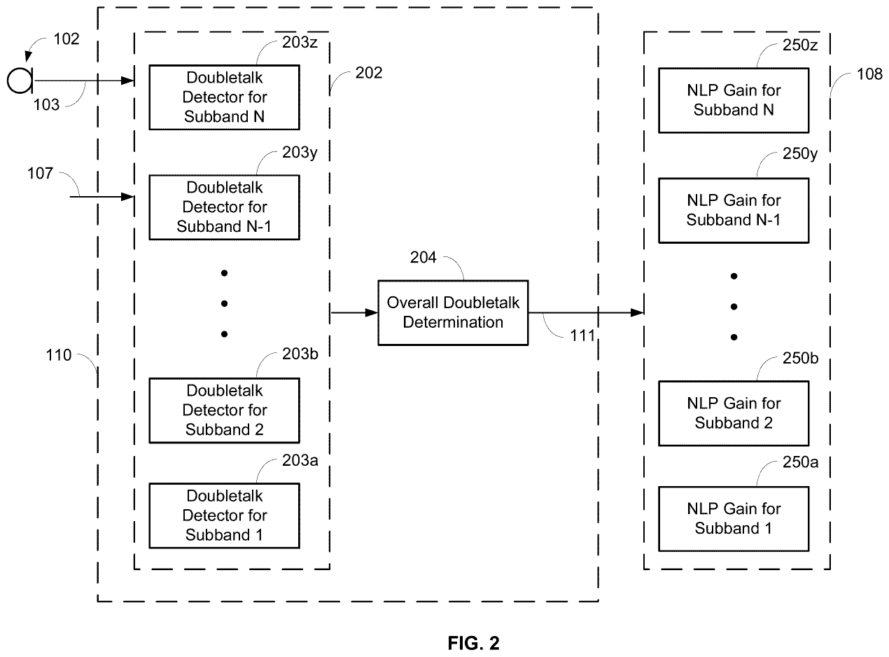

FIG. 5 shows an embodiment of a method 404 for detecting whether an overall doubletalk condition is present. The method 404 shown in FIG. 5 may correspond to step 404 of the method 400 shown in FIG. 4. In the method 404 of FIG. 5, the doubletalk detector 110 may determine whether each subband of the microphone audio signal 103 and the remote audio signal 101 received at step 402 has a doubletalk condition, such as at step 502. FIG. 2 shows an exemplary embodiment of portions of the doubletalk detector 110 as well as the non-linear processor 108. In particular, subband doubletalk detectors 203a, b, . . . , y, z corresponding to each of any number of subbands of the microphone audio signal 103 and a filtered remote audio signal 107 (which is based on the remote audio signal 101) may determine whether there is a doubletalk condition in each specific subband at step 502.

In embodiments, each of the subband doubletalk detectors 203a, b, . . . , y, z may detect a doubletalk condition by comparing, for a particular subband, the microphone audio signal 103 to a filtered remote audio signal 107 from the adaptive filter 106. The filtered remote audio signal 107 may be an estimate of the acoustic path of the remote audio signal 101. Accordingly, a doubletalk condition for a particular subband can be detected by the subband doubletalk detectors 203a, b, . . . , y, z when the level of the microphone audio signal 103 is higher than the filtered remote audio signal 107 by a threshold amount. There may be any suitable number of subband doubletalk detectors 203a, b, . . . , y, z. For example, in one embodiment, there may be fourteen subbands over a frequency range of 0-5 kHz, along with corresponding subband doubletalk detectors 203a, b, . . . , y, z.

At step 504, the number of subbands that have a doubletalk condition present may be compared to a doubletalk condition criteria, such as by the overall doubletalk determination unit 204. In embodiments, the doubletalk condition criteria may be a numerical range, a percentage range, a numerical threshold, or a percentage threshold of the number of subbands that have a doubletalk condition present. For example, an overall doubletalk condition may be determined to be present by the overall doubletalk determination unit 204 if the number of subbands that have a doubletalk condition exceeds a certain minimum number but is less than a certain maximum number. As another example, an overall doubletalk condition may be determined to be present by the overall doubletalk determination unit 204 if 30% of the number of subbands has a doubletalk condition (e.g., five out of fourteen subbands).

If the number of subbands that have a doubletalk condition present satisfies the doubletalk condition criteria at step 504 (“YES” branch of step 504), then the method 404 may continue to step 506. At step 506, the overall doubletalk determination unit 204 may set the doubletalk detection signal 111 to denote that there is an overall doubletalk condition involving the microphone audio signal 103 and the remote audio signal 101. However, if the number of subbands that have a doubletalk condition present does not satisfy the doubletalk condition criteria at step 504 (“NO” branch of step 504), then the method 404 may continue to step 508. At step 508, the overall doubletalk determination unit 204 may clear the doubletalk detection signal 111 to denote that there is not an overall doubletalk condition involving the microphone audio signal 103 and the remote audio signal 101.

Returning to the method 400 of FIG. 4, at step 406, if a doubletalk condition has been detected at step 404 (“YES” branch of step 406), e.g., by the doubletalk detection signal 111 being set by the doubletalk detector 110, then the method 400 may continue to step 408. At step 408, the gains in the non-linear processor 108 for particular subbands of the initial echo-cancelled audio signal 109 may be overridden and modified. Prior to step 408 and/or prior to the method 400, the overridden gains may have been initially generated by the non-linear processor 108 for the particular subbands of the initial echo-cancelled audio signal 109. In embodiments, the particular subbands with gains in the non-linear processor 108 that may be modified at step 408 may include the subbands that do not have a doubletalk condition present. For example, the gains of these particular subbands that do not have a doubletalk condition present may be increased such that their attenuation by the non-linear processor 108 is reduced. This can result in more desired sound (e.g., near end voice) being included by the non-linear processor 108 in the final echo-cancelled audio signal 113, since the energy of the near end audio is greater than the energy of the far end audio in these particular subbands that do not have a doubletalk condition present. Moreover, these particular subbands that do not have a doubletalk condition present will likely include fundamental speech frequencies that are more pertinent for intelligibility. In embodiments, the final echo-cancelled audio signal 113 may be transmitted to the far end remote location and/or utilized for local sound reinforcement.

As depicted in FIG. 2, the gains 250a, b, . . . , y, z for particular subbands may be modified in the non-linear processor 108, dependent on whether there is an overall doubletalk condition and whether a particular subband does or does not have a doubletalk condition present. In one example, when the doubletalk detection signal 111 denotes that there is an overall doubletalk condition, a doubletalk condition has not been detected in subbands 1 and 2 by respective subband doubletalk detectors 203a and 203b, while a doubletalk condition has been detected in other subbands (e.g., N and N−1) by their respective subband doubletalk detectors 203. In this example, the gains 250a and 250b for subbands 1 and 2 may be overridden and modified in the non-linear processor 108 while the other gains 250 are left unmodified in the non-linear processor 108.

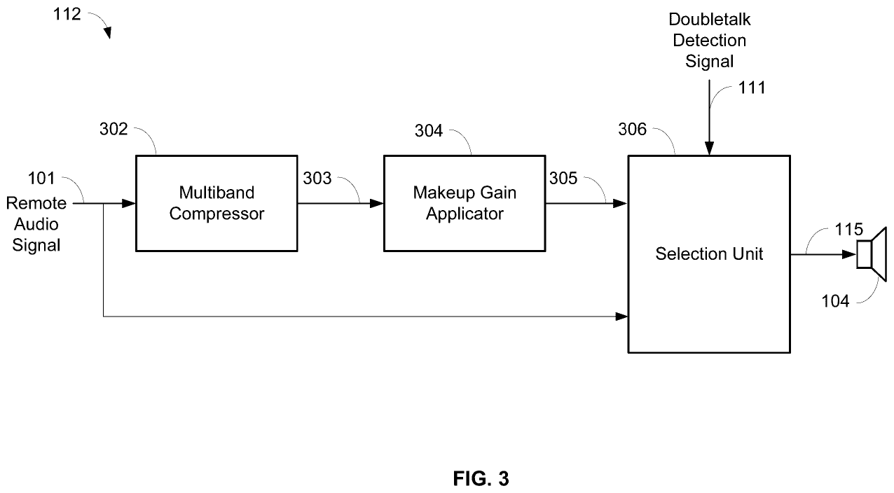

Returning to FIG. 4, after step 408, the method 400 may continue to step 410 to select a compressed gain-corrected remote audio signal 305 for output on the loudspeaker 104. As described in more detail below with respect to FIGS. 3 and 6, the remote audio signal 101 may be processed by the compressor 112 to reduce its dynamic range and lower its volume, as well as to have makeup gain applied. The compressed gain-corrected remote audio signal 305 generated by the compressor 112 can be played on the loudspeaker 104 as output audio signal 115 instead of the remote audio signal 101.

Returning to step 406, if a doubletalk condition has not been detected at step 404 (“NO” branch of step 406), e.g., by the doubletalk detection signal 111 being cleared by the doubletalk detector 110, then the method 400 may continue to step 412. At step 412, the remote audio signal 101 may be selected to be played as the output audio signal 115 on the loudspeaker 104. It should be noted that when a doubletalk condition has not been detected at step 404, the operation of the non-linear processor 108 is not overridden and the initially generated gains of the non-linear processor 108 are not modified.

FIG. 6 shows an embodiment of a method 410 for compressing and applying makeup gain to the remote audio signal 101 when a doubletalk condition has been detected at step 406. The method 410 shown in FIG. 6 may correspond to step 410 of the method 400 shown in FIG. 4. In the method 410 of FIG. 6, the compressor 112 may compress the remote audio signal 101 at step 602 to reduce its dynamic range and lower its volume to generate a compressed remote audio signal 303, such as by using a multiband compressor 302 as shown in the exemplary embodiment in FIG. 3. In embodiments, the multiband compressor 302 may split the remote audio signal 101 into separate bands so that each band can be compressed independently, such as by compressing lower frequencies and preserving higher frequencies (or vice versa).

The multiband compressor 302 may compress the remote audio signal 101 at step 602 as a function of the energy of the microphone audio signal 103, in some embodiments. For example, the remote audio signal 101 may be more compressed when the energy of the microphone audio signal 103 is relatively high, and the remote audio signal 101 may be less compressed when the energy of the microphone audio signal 103 is relatively low and/or when there is no doubletalk condition detected. In other embodiments, the multiband compressor 302 may compress the remote audio signal 101 at step 602 by a constant amount.

The method 410 may continue to step 604 where a makeup gain applicator 304 may apply makeup gain to the compressed remote audio signal 303 and generate a compressed gain-corrected remote audio signal 305. Adding makeup gain to the compressed remote audio signal 303 can minimize fluctuations in the amplitude of the audio played on the loudspeaker 104 by amplifying the level of certain subbands of the compressed remote audio signal 303 to be more consistent with the level of other subbands of the compressed remote audio signal 303. The resulting compressed gain-corrected remote audio signal 305 may have a more even audio level and improve the audio heard by listeners of the loudspeaker 104.

As described previously, depending on whether a doubletalk condition has been detected at step 406, either the compressed gain-corrected remote audio signal 305 or the remote audio signal 101 may be selected at step 410 or step 412, respectively, to be played as the output audio signal 115 on the loudspeaker 104. In the compressor 112, a selection unit 306 may be utilized to select the compressed gain-corrected remote audio signal 305 or the remote audio signal 101 as the output audio signal 115, based on the state of the doubletalk detection signal 111. In particular, the compressed gain-corrected remote audio signal 305 may be selected as the output audio signal 115 when the doubletalk detection signal 111 is set (indicating that an overall doubletalk condition is present), and the remote audio signal 101 may be selected as the output audio signal 115 when the doubletalk detection signal 111 is cleared (indicating that an overall doubletalk condition is not present). The selection unit 306 may be a matrix mixer, in some embodiments. In other embodiments, the selection unit 306 may be a multiplexer or other suitable device. By selecting the compressed gain-corrected remote audio signal 305 as the output audio signal 115 when there is an overall doubletalk condition, the operation of the non-linear processor 108 may be optimized due to the improvement of the ratio of the energy of the near end audio to the energy of the remote audio. In some embodiments, the selection unit 306 may select the compressed remote audio signal 303 and/or the compressed gain-corrected remote audio signal 305 to be played as the output audio signal 115 on the loudspeaker 104 when no doubletalk condition is present.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

The description herein describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1-20. (canceled)

21. A device, comprising:
one or more processors configured to:
determine that a doubletalk condition is present in one or more subbands of an initial echo-cancelled audio signal; and
modify gains of one or more other subbands of the initial echo-cancelled audio signal.

22. The device of claim 21, wherein the one or more other subbands of the initial echo-cancelled audio signal comprise subbands of the initial echo-cancelled audio signal that do not have a double talk condition present therein.

23. The device of claim 22, wherein modifying the gains of the one or more other subbands of the initial echo-cancelled audio signal comprises increasing the one or more gains.

24. The device of claim 21, wherein the initial echo-cancelled audio signal is based on a microphone signal and a remote audio signal.

25. The device of claim 24, wherein the one or more processors are further configured to:
generate a final echo-canceled audio signal based on the modified gains of the one or more other subbands of the initial echo-cancelled audio signal; and
transmit the final echo-cancelled audio signal to a remote location.

26. The device of claim 25, wherein the remote audio signal is received from the remote location.

27. The device of claim 24, wherein the one or more processors are configured to:
determine that the doubletalk condition is present in the one or more subbands of the initial echo-cancelled audio signal based on a ratio of a first energy of the microphone signal to a second energy of the remote audio signal.

28. The device of claim 24, wherein the one or more processors are further configured to:
generate a compressed remote audio signal by compressing the remote audio signal; and
play the compressed remote audio signal on a loudspeaker.

29. The device of claim 28, wherein compressing the remote audio signal comprises limiting a volume of one or more subbands of the remote audio signal.

30. The device of claim 28, wherein compressing the remote audio signal comprises reducing a dynamic range of the remote audio signal.

31. The device of claim 28, wherein the one or more processors are further configured to:
generate a compressed gain-corrected remote audio signal by applying a makeup gain to the compressed remote audio signal.

32. A method, comprising:
determining that a doubletalk condition is present in one or more subbands of an initial echo-cancelled audio signal; and
modifying gains of one or more other subbands of the initial echo-cancelled audio signal.

33. The method of claim 32, wherein the one or more other subbands of the initial echo-cancelled audio signal comprise subbands of the initial echo-cancelled audio signal that do not have a double talk condition present therein.

34. The method of claim 32, further comprising:
generating a final echo-canceled audio signal based on the modified gains of the one or more other subbands of the initial echo-cancelled audio signal; and
transmitting the final echo-cancelled audio signal to a remote location.

35. The method of claim 32, wherein the initial echo-cancelled audio signal is based on a microphone signal and a remote audio signal.

36. The method of claim 35, wherein the doubletalk condition is determined to be present in the one or more subbands of the initial echo-cancelled audio signal based on a ratio of a first energy of the microphone signal to a second energy of the remote audio signal.

37. The method of claim 35, further comprising:
generating a compressed remote audio signal by compressing the remote audio signal to generate a compressed remote audio signal; and
playing the compressed remote audio signal on a loudspeaker.

38. The method of claim 37, wherein
compressing the remote audio signal comprises limiting a volume of one or more subbands of the remote audio signal.

39. The method of claim 37, wherein compressing the remote audio signal comprises reducing a dynamic range of the remote audio signal.

40. The method of claim 37, further comprising:
generating a compressed gain-corrected remote audio signal by applying a makeup gain to the compressed remote audio signal to generate a compressed gain-corrected remote audio signal.
